(19) United States
(12) Patent Application Publication
(10) Pub. No.: US 2006/0122056 A1
(43) Pub. Date: Jun. 8, 2006

(54) Process to retain nano-structure of catalyst particles before carbonaceous nano-materials synthesis

(75) Inventors: Bhabendra Pradhan, Marietta, GA (US); Paul E. Anderson, Marietta, GA (US); Matthew Miller, Kennesaw, GA (US); Danny Hickingbottom, Kennesaw, GA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignee: Columbian Chemicals Company

(21) Appl. No.: 11/002,388

(22) Filed: Dec. 2, 2004

(51) Int. Cl. B01J 23/74

(52) U.S. Cl. 502/325

(57) ABSTRACT

In the novel process, a metal oxide is heated in a reactor under 20% H2 gas at a heating rate of 5 degrees C./min to 450 degrees C.; the catalyst is held there for 30 minutes, followed by exposure to 10-20% CO for another 30 minutes; then cooled down to room temperature. The resultant catalyst is then used for synthesis of carbon fibers at 550 and 600 degrees C. In an additional embodiment the catalyst once produced is removed from the reactor, and a new batch of metal oxide catalyst is placed in the reactor to provide a continuous production process.

### CROSS-REFERENCE TO RELATED APPLICATIONS

None

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to carbonaceous Nano-Materials synthesis. More particularly, the present invention relates to a process for an improved catalyst used in carbonaceous Nano-Materials synthesis which does not require a long pre-reduction time and passivation and which also preserves the original catalyst particle size.

2. General Background of the Invention

In the present state of the art of synthesizing carbon nanofibers, a pre-reduction of the catalyst, which is usually metal oxides or mixed metal oxides, for around 20 hours under hydrogen is required. This step is followed by passivation with 2-5% oxygen (to produce a thin metal oxide cover over the metal core.) These steps are very time consuming, in that they require 21-24 hours during which time the catalyst particles tend to sinter resulting in poor control of the finished catalyst particle size, and the resultant carbon fiber diameter. In this conventional prior art process, the first step is reduction of metal oxide under 10-20% H2 at 600 degrees C. for 20 hours. This is followed by passivation at room temperature for one hour under 2-5% oxygen gas.

In the current state of the art process, the passivated catalyst used to synthesize carbon fiber is prepared by, for example, placing iron oxide of 0.3 g·wt. within a reactor wherein it is reduced at 600 degrees C. for 20 hours with 10% hydrogen (balance with nitrogen). The resultant product is cooled to room temperature under the same gas mixture or under N₂ only, then passivated for one hour using 2% oxygen (balanced with nitrogen). The final weight of the passivated catalyst is 0.195 g. The passivated catalyst was heated to 600 degrees C. under 10% hydrogen and held for two hours. A mixture of carbon monoxide and hydrogen (4:1 molar) was then passed over the catalyst at a rate of 200 sccm to produce carbon nanofibers as shown in FIG. 1C. The carbon production rate was 6 g. carbon/g catalyst per hour.

### BRIEF SUMMARY OF THE INVENTION

In the process of the present invention, an improved catalyst is produced that does not require any long pre-reduction time and passivation. In the novel process, a metal oxide catalyst precursor is heated in a reactor under 20% H2 gas at a heating rate of 5 degrees C./min to 450 degrees C.; held thereat for 30 minutes, exposed to 10-20% CO for another 30 minutes; then cooled down to room temperature. The resultant catalyst contains a thin carbonaceous coating sufficient to provide passivation but insufficient to cause encapsulation which would result in deactivation of catalyst for further uses. The catalyst is then used to synthesize carbon fibers from a carbon containing precursor and hydrogen mixture at 550 to 600 degrees C.

It is foreseen that the reduced time required for production of the catalyst of the present invention, when coupled with pneumatic catalyst and product transfer means, would facilitate sequential, repetitive catalyst preparation and carbon fiber synthesis operations within a reactor thus avoiding the interruptions associated with conventional batch processing.

All percentages of gaseous constituents in the present application are volumetric.

For purposes of this application the terms “carbonaceous nano-materials” and “carbonaceous nano-fibers” are used interchangeably and have equivalent meanings.

Therefore, it is a principal object of the present invention to produce a catalyst used in carbon nano-fiber synthesis which does not require long pre-reduction time and passivation;

It is a further object of the present invention to produce a catalyst used in carbon nano-fiber synthesis which improves the yield of the nano-fiber product;

It is a further object of the present invention to produce a catalyst used in carbon nano-fiber synthesis which provides superior reactivity;

It is a further object of the present invention to produce a catalyst which preserves the initial catalyst particle size and controls the diameter of the resultant carbon nano-fibers;

It is a further object of the present invention to provide a catalyst which permits continuous production of carbon nano-fibers.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1A is a TEM micrograph of the metal oxide starting material for the process of the present invention;

FIG. 1B is a TEM micrograph of the passivated catalyst utilizing the conventional method;

FIG. 1C is a TEM micrograph of the nano-carbon product produced with the passivated catalyst of the conventional method;

FIG. 2 is a TEM micrograph of the carbon coated catalyst produced in the present invention;

FIG. 3 is a TEM micrograph of the carbon fiber synthesized utilizing the catalyst in the present invention as shown in FIG. 2;

FIG. 4 is a second TEM micrograph of the carbon fiber synthesized utilizing the catalyst shown in FIG. 2;

FIG. 5 is a TEM micrograph of a carbon coated catalyst produced from metal oxides in the process of the present invention;

FIG. 6 is a TEM micrograph of the carbon fiber synthesized utilizing the catalyst shown in FIG. 5 of the present invention;

FIG. 7 is a second TEM micrograph of the carbon fiber synthesized utilizing the catalyst as shown in FIG. 5 in the present invention; and

FIG. 8 is a TEM micrograph of carbon fiber produced by the process of the present invention operating in continuous mode.

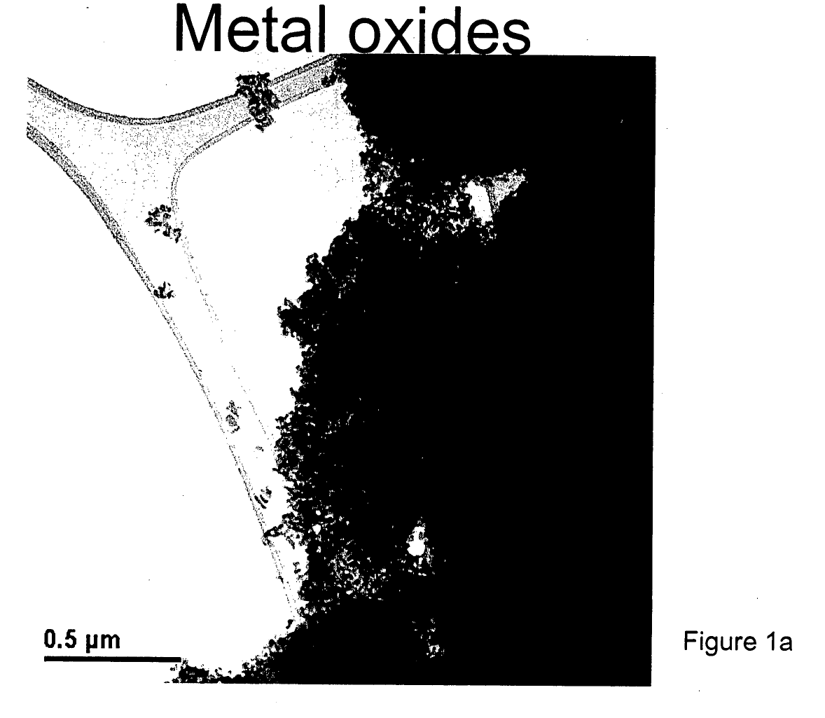

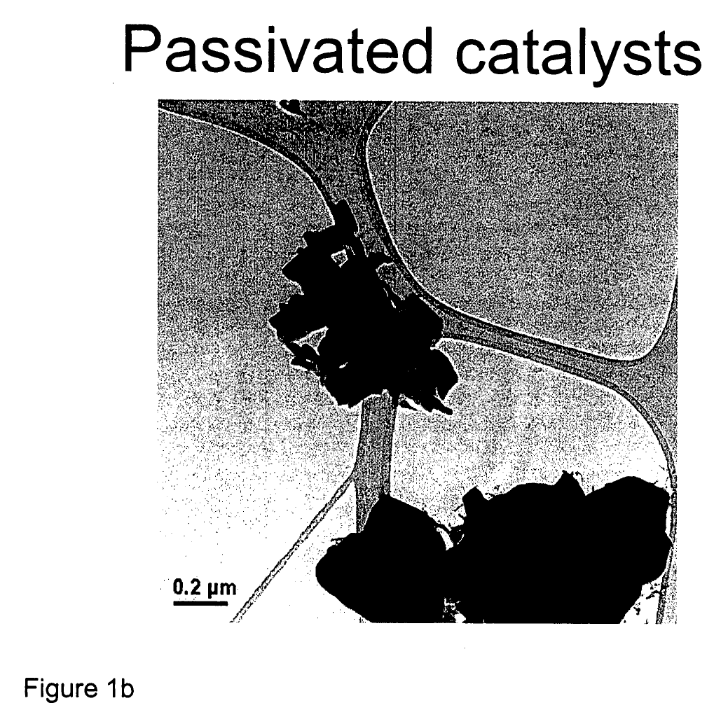

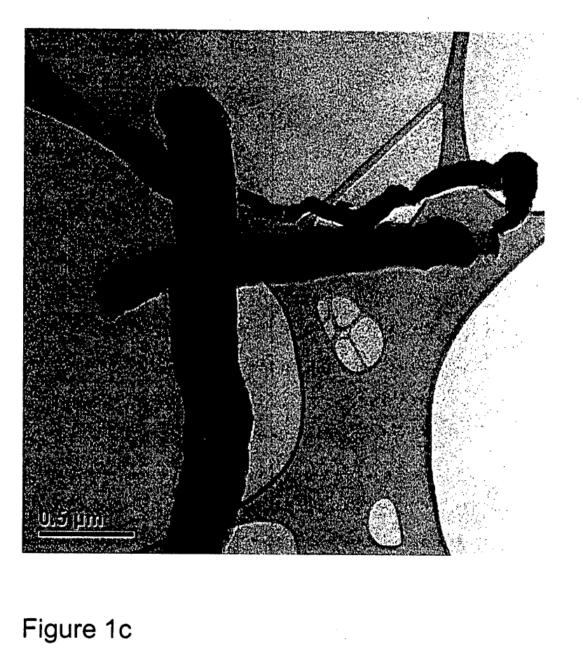

Table 1 is a table of the comparative results of Conventional versus Inventive Catalyst of the Present invention.

### DETAILED DESCRIPTION OF THE PREFERRED EMBODIMENTS

The present invention provides a new and inventive process for an improved catalyst that does not require any long pre-reduction time and passivation. The catalyst precursor is heated under 20% hydrogen gas at a heating rate of 5° C. per minute to 450° C. and is held thereat for 30 minutes, exposed to 10-20% CO for an additional 30 minutes then is cooled down to room temperature. The resultant catalyst contains a thin carbonaceous coating sufficient to provide passivation but insufficient to cause incapsulation which would result in deactivation. This catalyst is then used for synthesis of carbon fibers from a carbon monoxide and hydrogen mixture at 550 to 600° C. The result, as found in the examples, is a more uniform product produced at a higher production rate than for the conventional method which requires pre-reduction, cooling, passivation, re-reduction, and return to reaction temperature. The improved process provides a saving of time and improvement of yield, higher reactivity, and preserves the initial catalyst particle size and hence controls the diameter of the resultant carbon nano fibers as will be seen in the following examples. Furthermore, the following examples will show that the catalyst of the present invention can be used to produce carbon fibers in either batch or continuous mode.

### EXAMPLE 1

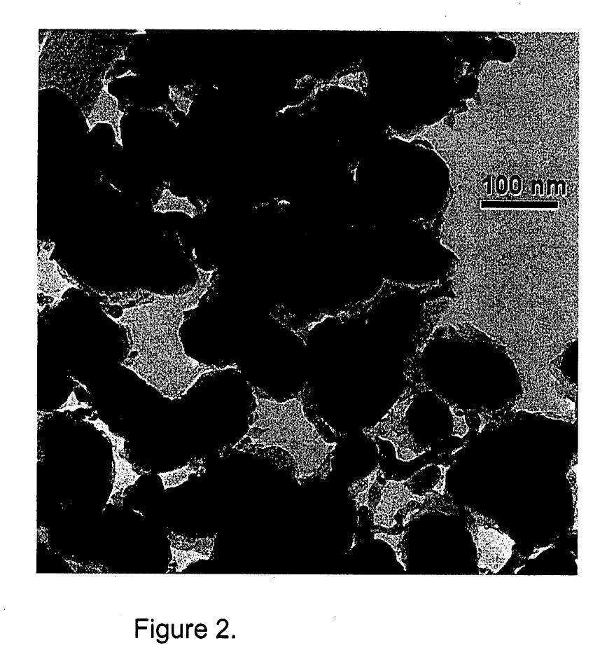

Iron oxide of 0.3 grams wt. is placed inside a reactor and heated at a heating rate of 5° C. per minute to 450° C., held there for 30 minutes under 20% hydrogen (balanced with nitrogen) at a total flow of 200 sccm. The gases were switched to 10% CO with 20% hydrogen gas (balanced with nitrogen) for 30 minutes to carbon coat the individual catalyst particles to retain their structure. These particles were cooled to room temperature under nitrogen. The structure of these catalyst particles are shown as a TEM micrograph in FIG. 2. There is an estimation of 0.47 grams carbon/gram catalyst on this process.

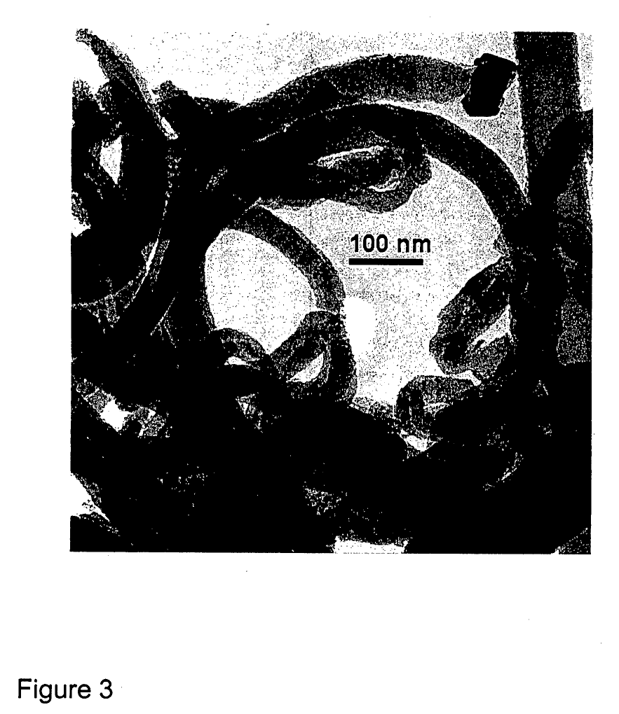

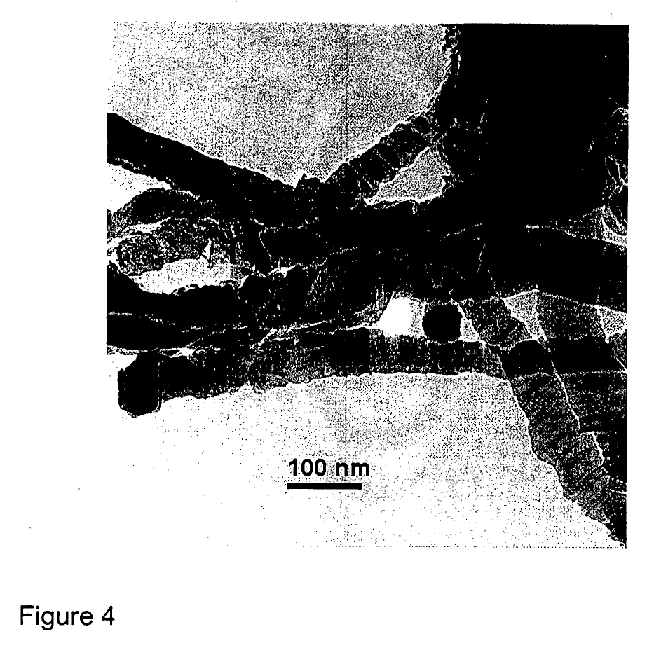

In the synthesis of fiber by using the catalyst as described above, 0.1 grams of the above carbon coated catalyst was placed inside a quartz reactor and temperature was increased to 550° C. (and also to 600° C.) with a heating rate of 5° C. per minute under 20% hydrogen (balanced with nitrogen). Once the reaction temperature reached the set point, gases were switched to 80% CO and 20% hydrogen for two hours to synthesize the nano-carbon products. The resultant products are shown in TEM micrograph FIGS. 3 (550° C. synthesis) and 4 (600° C. synthesis). The carbon production rate was 16.28 and 13.32 grams carbon/gram catalyst per hour respectively for synthesis temperature 550° and 600° C. Bulk density varied from 0.076 to 0.123. It should be noted that the production rate was greater than 2 times that of the rate obtained with the conventional prior art catalyst as described in the background of the invention.

### EXAMPLE 2

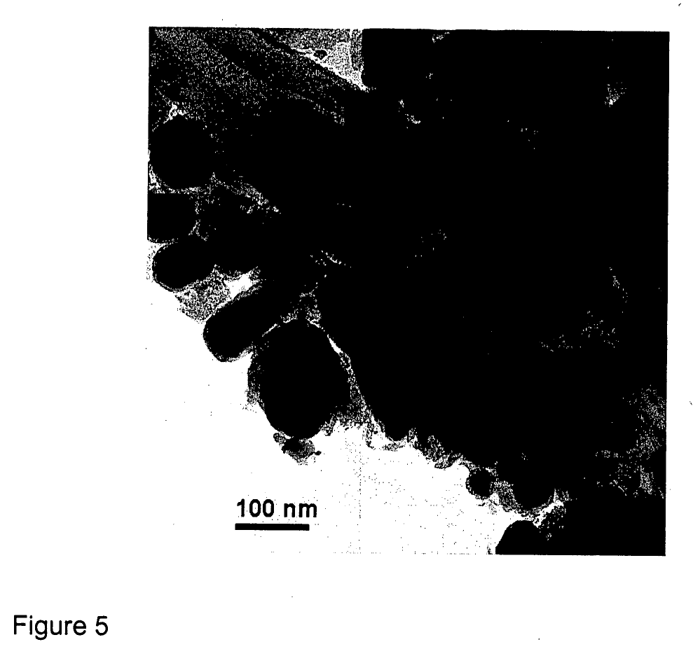

Iron oxide of 0.3 grams wt. was placed inside the reactor and heated at a rate of 5° C./minute to 450° C., held there for 30 minutes under 20% hydrogen (balanced with nitrogen) at a total flow of 200 sccm. The gases were switched to 20% CO with 20% hydrogen (balanced with nitrogen) for 30 minutes to carbon coat the individual catalyst particles to retain their structure. The resultant catalyst was cooled to room temperature under nitrogen. The structure of these catalyst particles is shown in TEM micrograph, FIG. 5. There is an estimation of 0.80 grams carbon/gram catalyst on this process.

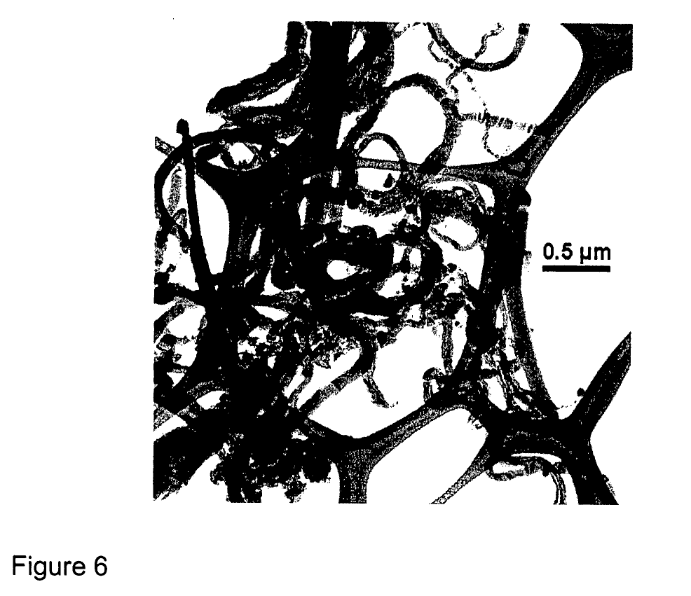

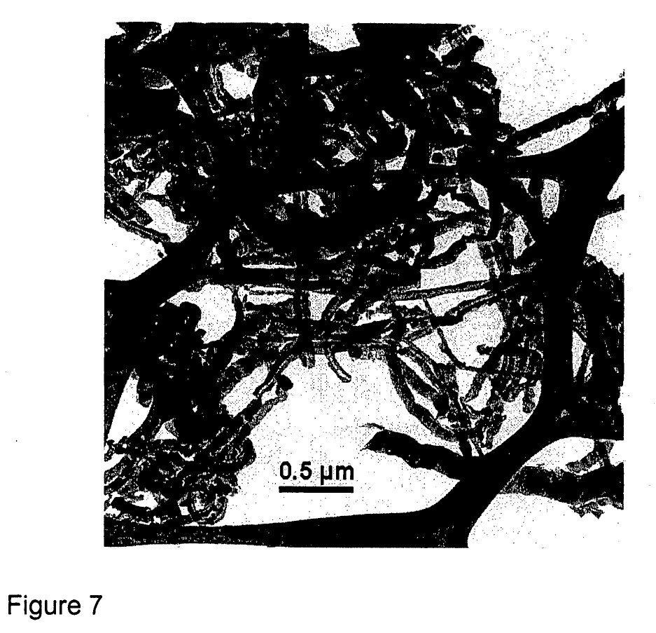

In the synthesis of the nano-carbon fiber using the above referenced catalyst, 0.1 gram of the above carbon coated catalyst were placed inside a quartz reactor and the temperature was increased to 550° C. (and also to 600° C.) with a heating rate of 5° C. per minute under 20% hydrogen (balanced with nitrogen). Once the reaction temperature reached the set point, gases were switched to 80% CO and 20% hydrogen (balanced with nitrogen) for two hours to synthesize the nano-carbon products. The resultant carbon products are shown in TEM micrograph FIGS. 6 (550° C. synthesis) and 7 (600° C. synthesis). The carbon production rate was 18.06 and 15.2 grams/gram catalyst per hour respectively for synthesis temperature 550° and 600° C. Bulk density varied from 0.076 to 0.228. It is noteworthy that the production rate was greater than 2 to 3 times that of the prior art catalyst preparation method that was described in the background of the invention.

### EXAMPLE 3

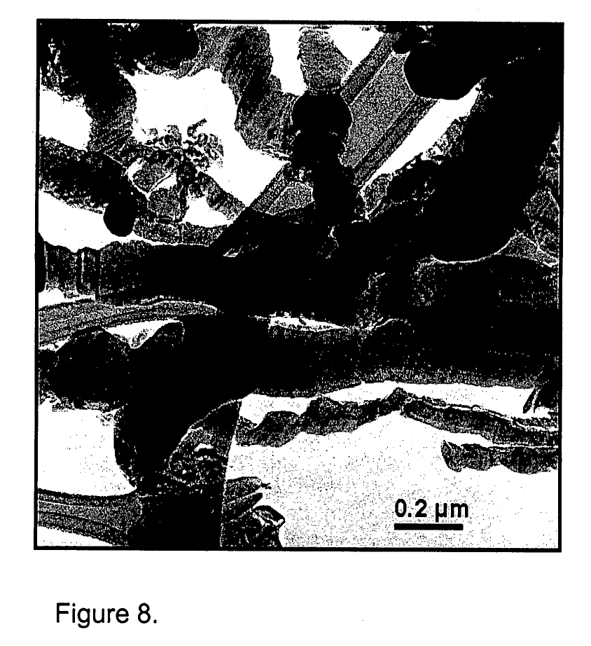

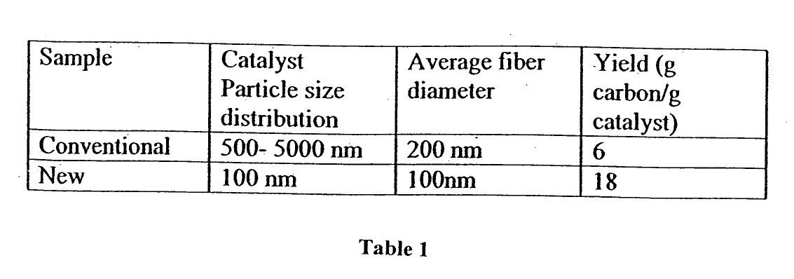

Synthesis of carbon fiber continuously by using the above produced catalyst was achieved by utilizing 0.5 grams of the carbon coated catalyst charged into a vertical quartz reactor and the temperature of the reactor was maintained at 550° C. under 20% hydrogen (balanced with nitrogen). Gases were switched to 80% CO and 20% hydrogen for 1 hour to synthesize the nano-carbon products. After this reaction time the products were pneumatically discharged from the reactor and a new batch of catalyst was charged into the bed and the process was allowed to continue. These carbon products are shown in the TEM micrograph, in FIG. 8.

Table 1 illustrates the comparative results between the conventional and inventive catalyst preparation. As seen in the Table 1, the catalyst particle size distribution for the conventional process is 500-5000 nm, while the process of the present invention results in a near monodisperse particle size of 100 nm. The average fiber diameter for the conventional process and catalyst is 200 nm while for the new catalyst it is 100 nm. Finally the yield with the conventional process is 6 g carbon/g catalyst/hour, while the yield from the new process is 13-18 g carbon/g catalyst/hour.

Supplemental to the specific examples as noted above, the following ranges of parameters for the process of the present invention are believed to be operable. Gas compositions for reduction from 5% to 20% H₂ in inert diluent, hold time from 5-60 minutes, reduction temperature from 300-500° C., ramp rate from 1-10° C. per minute, passivation gas composition from 1%-30% of both H₂ and CO in inert diluent, passivation temperature from 300-500° C., passivation time from 1-60 minutes, synthesis temperatures from 500-700° C., and synthesis gas composition ranges (CO/H₂) from 1:10 to 10:1. Other synthesis gas compositions wherein the carbon containing precursor comprises methane, acetylene, ethane, ethylene, benzene, alkylbenzenes, alcohols, higher alkanes, and cycloalkanes can also be employed.

The foregoing embodiments are presented by way of example only; the scope of the present invention is to be limited only by the following claims.

What is claimed is:

1. A process for producing a catalyst for use in synthesizing carbon nanofibers, comprising the following steps:
a) providing a metal oxide or mixed metal oxide;
b) heating the metal oxide under 5-20% hydrogen in inert diluent gas to 300-500° C.;
c) holding the temperature for 5-60 minutes;
d) exposing the catalyst to a gas comprising 1-30% H₂ and 1-30% CO in inert diluent for 10 to 60 minutes at 300-500° C.; and
e) allowing the catalyst to cool to approximately room temperature.

2. The process of claim 1, further comprising the step of utilizing the produced catalyst to produce carbon nanofibers from mixtures of carbon containing precursor, hydrogen, and inert diluent at temperatures of 500-700° C.

3. The process of claim 2, wherein the carbon containing precursor comprises CO, methane, acetylene, ethane, ethylene, benzene, alkylbenzenes, alcohols and higher alkanes and cycloalkanes.

4. A process for producing a catalyst for use in synthesizing carbon nanofibers, comprising the following steps:
a. providing a metal oxide;
b. heating the metal oxide under 20% hydrogen gas to 450 degrees C.;
c. holding the temperature for 30 minutes;
d. exposing the catalyst to 5-40% CO for 30 minutes;
e. allowing the catalyst to cool to approximately room temperature.

5. The process of claim 4, wherein the resulting catalyst is used to synthesize carbon fibers at 550-600 degrees C. for two hours.

6. The process of claim 4, wherein the metal oxide is one selected from a group comprising Fe, Ni, Co, Cu and Mo or mixture of these metal oxides.

7. The process of claim 4, wherein the catalyst is heated to the 450 degrees C. at 5 degrees C./min.

8. The process of claim 4, wherein the catalyst is produced for use in synthesizing carbon nano-fibers.

9. The process of claim 4, wherein the process takes place in a vertical quartz reactor.

10. A process for producing a catalyst for use in synthesizing carbon nanofibers, which produces higher yields, higher reactivity, and preserves the structure of the catalyst, comprising the following steps of heating a metal oxide in around 20% Hydrogen gas to 450 degrees C.; exposing the catalyst to CO gas for around 30 minutes prior to its use in the synthesizing process.

11. A process for continuously producing a catalyst for use in synthesizing carbon nano-fiber materials, which produces higher yields, higher reactivity, and preserves the structure of the catalyst, comprising the following steps:
a. heating a metal oxide in around 20% Hydrogen gas to 450 degrees C. in a reactor;
b. exposing the catalyst to CO gas for around 30 minutes;
c. discharging the catalyst from the reactor and providing a new batch of metal oxide for production of more cataylst.

12. The process of claim 10, wherein the metal oxide is one selected from a group comprising Fe, Ni, Co, Cu, Mo or mixture of these metal oxides.

13. The process of claim 11, wherein the metal oxide is one selected from a group comprising Fe, Ni, Co, Cu, Mo or mixture of these metal oxides.
